(19) United States
(12) Patent Application Publication
(10) Pub. No.: US 2023/0060634 A1
(43) Pub. Date: Mar. 2, 2023

(54) METHODS FOR FABRICATING TWO-DIMENSIONAL ANODE MATERIALS

(71) Applicant: GM GLOBAL TECHNOLOGY OPERATIONS LLC, Detroit, MI (US)

(72) Inventors: Thomas E. MOYLAN, Troy, MI (US); Jeffrey David CAIN, Royal Oak, MI (US)

(73) Assignee: GM GLOBAL TECHNOLOGY OPERATIONS LLC, Detroit, MI (US)

(21) Appl. No.: 17/465,012

(22) Filed: Sep. 2, 2021

(51) Int. Cl. H01M 4/04; H01M 4/36; H01M 4/48; C01B 33/12

(52) U.S. Cl. CPC H01M 4/049; H01M 4/366; H01M 4/483; C01B 33/12; H01M 2004/027

(57) ABSTRACT

The present disclosure provides methods for forming a two-dimensional silicon oxide negative electroactive material. The methods include contacting a two-dimensional silicon allotrope and an oxidizing agent in an environment having a temperature of greater than or equal to about 25° C. to less than or equal to about 1,000° C., where the contacting of the two-dimensional silicon allotrope and the oxidizing agent causes the two-dimensional silicon allotrope to oxidize and form the two-dimensional silicon oxide negative electroactive material. In certain variations, the oxidizing agent includes oxygen and the contacting of the two-dimensional silicon allotrope and the oxidizing agent may include disposing the two-dimensional silicon allotrope in an oxygen-containing environment comprising less than or equal to about 21% of oxygen. In other variations, the oxidizing agent includes a wet chemical agent.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions and electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

Many different materials may be used to create components for a lithium ion battery. For example, positive electrode materials for lithium batteries typically comprise an electroactive material which can be intercalated with lithium ions, such as lithium-transition metal oxides or mixed oxides, for example including LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or one or more phosphate compounds, for example including lithium iron phosphate or mixed lithium manganese-iron phosphate. The negative electrode typically includes a lithium insertion material or an alloy host material. For example, typical electroactive materials for forming an anode include graphite and other forms of carbon, silicon and silicon oxide, tin and tin alloys.

Certain anode materials have particular advantages. While graphite having a theoretical specific capacity of 372 mAh·g⁻¹ is most widely used in lithium-ion batteries, anode materials with high specific capacity, for example high specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing material for rechargeable lithium ion batteries. However, anodes comprising silicon may suffer from drawbacks. For example, excessive volumetric expansion and contraction (e.g., about 400% for silicon as compared to about 10% for graphite) during successive charging and discharging cycles. Such volumetric changes may lead to fatigue cracking and decrepitation of the electroactive material, as well as pulverization of material particles, which in turn may cause a loss of electrical contact between the silicon-containing electroactive material and the rest of the battery cell resulting in poor capacity retention and premature cell failure. This is especially true at electrode loading levels required for the application of silicon-containing electrodes in high-energy lithium-ion batteries, such as those used in transportation applications. Accordingly, it would be desirable to develop high performance electrode materials, particularly comprising silicon and/or other electroactive materials that undergo significant volumetric changes during lithium ion cycling, and methods for preparing such high performance electrodes materials, for use in high energy and high power lithium ion batteries, that can address these challenges.

### SUMMARY

This section provides a general summary of the disclosure, and is not a comprehensive disclosure of its full scope or all of its features.

The present disclosure relates to a layered anode material (for example, two-dimensional (“2D”) silicon oxide), and methods of forming the same (for example, using chemical batch or flow processes).

In various aspects, the present disclosure provides a method for forming a two-dimensional silicon oxide negative electroactive material. The method may include contacting a two-dimensional silicon allotrope and an oxidizing agent in an environment having a temperature of greater than or equal to about 25° C. to less than or equal to about 1,000° C., where the contacting of the two-dimensional silicon allotrope and the oxidizing agent causes the two-dimensional silicon allotrope to oxidize and form the two-dimensional silicon oxide negative electroactive material.

In one aspect, the method may further include, prior to or simultaneously with the contacting of the two-dimensional silicon allotrope and the oxidizing agent, heating the environment to the temperature of greater than or equal to about 25° C. to less than or equal to about 1,000° C.

In one aspect, the environment may have a temperature greater than or equal to about 100° C. to less than or equal to about 1,000° C., the oxidizing agent may include oxygen, and the contacting of the two-dimensional silicon allotrope and the oxidizing agent may include disposing the two-dimensional silicon allotrope in an oxygen-containing environment comprising less than or equal to about 21% of oxygen.

In one aspect, the oxygen-containing environment may have an oxygen concentration greater than or equal to about 1 vol. % to less than or equal to about 21 vol. %.

In one aspect, the two-dimensional silicon allotrope may be maintained in the oxygen-containing environment for greater than or equal to about 10 minutes to less than or equal to about 300 minutes.

In one aspect, the environment may have a temperature greater than or equal to about 25° C. to less than or equal to about 100° C., and the oxidizing agent may include a wet chemical agent.

In one aspect, the wet chemical agent may include one or more nitrates, one or more peroxides, one or more persulfates, one or more permanganates, or any combination thereof.

In one aspect, the wet chemical agent may include a compound selected from the group consisting of: nitrite, nitrate, peroxide, sulfite, sulfate, persulfate, sulfuric acid, chlorate, chlorite, peroxymonosulfuric acid, peroxydisulfuric acid, permanganate, and combinations thereof.

In one aspect, the method may further include, after the contacting, carbon coating the two-dimensional silicon oxide negative electroactive material. The two-dimensional silicon oxide negative electroactive material may be carbon coated by exposing the two-dimensional silicon oxide material to one or more carbon containing fuels at temperatures of greater than or equal to about 600° C. to less than or equal to about 1,000° C.

In one aspect, the method may further include, after the contacting, prelithiating the two-dimensional silicon oxide negative electroactive material. The two-dimensional silicon oxide negative electroactive material may be prelithiated by exposing the two-dimensional silicon oxide negative electroactive material to an organic electrolyte.

In one aspect, the organic electrolyte may include a lithium salt selected from the group consisting of: lithium hexafluorophosphate, lithium bis(fluorosulfonyl)imide, lithium tetrafluoroborate, lithium bis(oxalate)borate, and combinations thereof and an organic solvent selected from the group consisting of: ethylene carbonate, propylene carbonate, dimethylcarbonate, diethylcarbonate, ethylmethylcarbonate, and combinations thereof.

In various aspects, the present disclosure provides a method for forming a two-dimensional silicon oxide negative electroactive material. The method may include disposing a two-dimensional silicon allotrope in an oxygen-containing environment. The oxygen-containing environment may be heated to a temperature of greater than or equal to about 100° C. to less than or equal to about 1,000° C. The oxygen-containing environment may have an oxygen concentration of greater than or equal to about 1 vol. % to less than or equal to about 21 vol. %. Heating the two-dimensional silicon allotrope in the oxygen-containing environment may cause the two-dimensional silicon allotrope to oxidize and form the two-dimensional silicon oxide negative electroactive material.

In one aspect, the two-dimensional silicon allotrope may be maintained in the oxygen-containing environment for greater than or equal to about 10 minutes to less than or equal to about 300 minutes.

In one aspect, the method may further include, after the contacting, carbon coating the two-dimensional silicon oxide negative electroactive material. The two-dimensional silicon oxide negative electroactive material may be carbon coated by exposing the two-dimensional silicon oxide material to one or more carbon containing fuels at temperatures greater than or equal to about 600° C. to less than or equal to about 1,000° C.

In one aspect, the method may further include, after the contacting, prelithiating the two-dimensional silicon oxide negative electroactive material. The two-dimensional silicon oxide negative electroactive material may be prelithiated by exposing the two-dimensional silicon oxide negative electroactive material to an organic electrolyte.

In various aspects, the present disclosure provides a method for forming a two-dimensional silicon oxide negative electroactive material. The method may include contacting a two-dimensional silicon allotrope and a wet chemical agent to form an admixture, and heating the admixture to a temperature of greater than or equal to about 25° C. to less than or equal to about 100° C., where the heating of the admixture causes the two-dimensional silicon allotrope to oxidize and form the two-dimensional silicon oxide negative electroactive material.

In one aspect, the wet chemical agent may include one or more nitrates, one or more peroxides, one or more persulfates, one or more permanganates, or any combination thereof.

In one aspect, the wet chemical agent may include a compound selected from the group consisting of: nitrite, nitrate, peroxide, sulfite, sulfate, persulfate, sulfuric acid, chlorate, chlorite, peroxymonosulfuric acid, peroxydisulfuric acid, permanganate, and combinations thereof.

In one aspect, the method may further include, after the contacting, carbon coating the two-dimensional silicon oxide negative electroactive material. The two-dimensional silicon oxide negative electroactive material may be carbon coated by exposing the two-dimensional silicon oxide material to one or more carbon containing fuels at temperatures of greater than or equal to about 600° C. to less than or equal to about 1,000° C.

In one aspect, the method may further include, after the contacting, prelithiating the two-dimensional silicon oxide negative electroactive material. The two-dimensional silicon oxide negative electroactive material may be prelithiated by exposing the two-dimensional silicon oxide negative electroactive material to an organic electrolyte.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including a layered (i.e., two-dimensional) electroactive material in accordance with various aspects of the present disclosure;

FIG. 2 is a flowchart illustrating an exemplary method for fabricating a layered (i.e., two-dimensional) electroactive material for use in an electrochemical battery cell, like the example electrochemical battery cell illustrated in FIG. 1, in accordance with various aspects of the present disclosure; and

FIG. 3 is a flowchart illustrating another exemplary method for fabricating a layered (i.e., two-dimensional) electroactive material for use in an electrochemical battery cell, like the example electrochemical battery cell illustrated in FIG. 1, in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure pertains to a layered (i.e., two-dimensional (“2D”) anode material for an electrochemical cell that cycles lithium ions, and to methods of forming the same. The layered anode material may be a two-dimensional silicon oxide material. Methods for forming the two-dimensional silicon oxide material may include oxidizing a layered (i.e., two-dimensional) silicon allotrope, for example by exposing the layered silicon allotrope to dilute oxygen, where the oxygen concentration and temperatures are controlled, and/or using wet chemical agents (e.g., nitrates, peroxides, persulfates, permanganates, and the like), where the oxidizing powers and temperatures are controlled. In each variation, the two-dimensional silicon oxide material may be subjected to one or more post treatments. For example, in various aspects, the two-dimensional silicon oxide material may be carbon coated by exposing the two-dimensional silicon oxide material to a carbon containing fuel (e.g., alkanes (such as, methane), alkenes (such as, ethylene, propylene), alkynes (such as, acetylene), and the like) at elevated temperatures. In various aspects, the two-dimensional silicon oxide material may be pre-lithiated by exposing the two-dimensional silicon oxide material to non-aqueous electrolytes, including lithium salts and organic solvents.

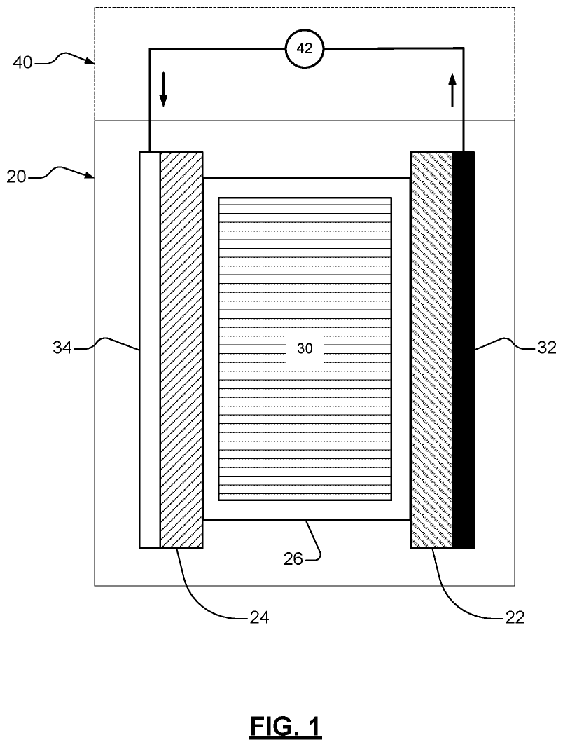

A typical lithium-ion battery includes a first electrode (such as, a positive electrode or cathode) opposing a second electrode (such as, a negative electrode or anode) and a separator and/or electrolyte disposed therebetween. The second electrode may include the layered (i.e., two-dimensional) anode material. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte. For example, the separator 26 may be defined by a plurality of solid-state electrolyte particles (not shown).

A negative electrode current collector 32 may be positioned at or near the negative electrode 22. The negative electrode current collector 32 may be a metal foil, metal grid or screen, or expanded metal comprising copper or any other appropriate electrically conductive material known to those of skill in the art. A positive electrode current collector 34 may be positioned at or near the positive electrode 24. The positive electrode current collector 34 may be a metal foil, metal grid or screen, or expanded metal comprising aluminum or any other appropriate electrically conductive material known to those of skill in the art. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries that include solid-state electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain variations, the separator 26 may also be mixed with a ceramic material or its surface may be coated in a ceramic material. For example, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), titania (TiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26.

In various aspects, the porous separator 26 and the electrolyte 30 in FIG. 1 may be replaced with a solid-state electrolyte (“SSE”) (not shown) that functions as both an electrolyte and a separator. The solid-state electrolyte may be disposed between the positive electrode 24 and negative electrode 22. The solid-state electrolyte facilitates transfer of lithium ions, while mechanically separating and providing electrical insulation between the negative and positive electrodes 22, 24. By way of non-limiting example, solid-state electrolytes may include LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

The positive electrode 24 may be formed from a lithium-based active material (or a sodium-based active material in the instance of sodium-ion batteries) that is capable of undergoing lithium intercalation and deintercalation, alloying and dealloying, or plating and stripping, while functioning as the positive terminal of the battery 20. The positive electrode 24 can be defined by a plurality of electroactive material particles (not shown) disposed in one or more layers so as to define the three-dimensional structure of the positive electrode 24. The electrolyte 30 may be introduced, for example after cell assembly, and contained within pores (not shown) of the positive electrode 24. For example, the positive electrode 24 may include a plurality of electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. The positive electrode 24 may have a thickness greater than or equal to 1 μm to less than or equal to 500 μm, and in certain aspects, optionally greater than or equal to 10 μm to less than or equal to 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1), lithium manganese nickel oxide (LiMn₍₂₋ₓ₎NiₓO₄, where 0≤x≤0.5) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄), lithium manganese-iron phosphate (LiMn₂₋ₓFeₓPO₄, where 0<x<0.3), or lithium iron fluorophosphate (Li₂FePO₄F).

In certain variations, the positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about 80 wt. % to less than or equal to about 99 wt. % of the positive electroactive material, greater than or equal to 0 wt. % to less than or equal to about 15 wt. % of the electronically conducting material, and greater than or equal to 0 wt. % to less than or equal to about 15 wt. %, and in certain aspects, optionally greater than or equal to 0 wt. % to less than or equal to about 15 wt. %, of the at least one polymeric binder.

The positive electrode 24 may include greater than or equal to 80 wt. % to less than or equal to 99 wt. % of the positive electroactive material, greater than or equal to 0 wt. % to less than or equal to 15 wt. % of the electronically conducting material, and greater than or equal to 0 wt. % to less than or equal to 15 wt. %, and in certain aspects, optionally greater than or equal to 0 wt. % to less than or equal to 15 wt. %, of the at least one polymeric binder.

The negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, the negative electrode 22 may include a plurality of electrolyte particles (not shown). In each instance, the negative electrode 22 may have a thickness greater than or equal to about 1 μm to less than or equal to about 500 μm, and in certain aspects, optionally greater than or equal to about 10 μm to less than or equal to about 200 μm. The negative electrode 22 may have a thickness greater than or equal to 1 μm to less than or equal to 500 μm, and in certain aspects, optionally greater than or equal to 10 μm to less than or equal to 200 μm.

In various aspects, the negative electroactive material includes an atomically layered anode material, where each crystallographic plane is considered a layer. The atomically layered anode material may include an oxide, for example, silicon oxide (SiOx, where 0.1≤x≤2), germanium oxide, and/or boron oxide. For example, in certain variations, the electroactive material may include a two-dimensional, layered allotrope of silicon oxide including planes of atoms strongly bound in-plane and weakly coupled out of plane (i.e., little to no bonding between layers) at an angstrom scale, similar to graphite. Although silicon oxide (SiOx, where 0.1≤x≤2) is detailed herein, the skilled artisan will appreciate that similar teachings apply to electroactive materials that include a two-dimensional, layered allotrope of germanium oxide and/or electroactive materials that include a two-dimensional, layered allotrope of boron oxide. In each instance, the atomically layered anode material may form micro/nano scale electroactive particles, for example electroactive material particles having an average diameter greater than or equal to about 100 nm to less than or equal to about 50 μm. The electroactive material particles may have an average diameter greater than or equal to 100 nm to less than or equal to 50 μm.

Such negative electroactive materials may exhibit improve cyclability, for example, the two-dimensional silicon oxide negative electroactive materials may have an intrinsic capacity of about 1400 mAh/g at about 100 mA/g current. The layered structure may serve to relieve internal stresses that arise during lithiation and enhance ionic diffusion within the negative electrode 22. For example, the two-dimensional structure may allow lithium ions to intercalate between the layers via pseudo van der Waals gaps, to store lithium ions (e.g., pre-lithiated) without destroying the lattice structure thereby helping to avoid pulverization or decrepitation of the structure (similar to intercalation of lithium in graphite). Additionally, the two-dimensional channels formed between layers may better facilitate ionic diffusion to permit faster charge rates.

In various aspects, micro/nano scale electroactive particles of the two-dimensional silicon oxide material may be carbon coated, so as to increase the electronic conductivity of the two-dimensional silicon oxide material, and as such, its cycle life. In certain variations, the carbon coating may be an amorphous or graphitic carbon having a thickness greater than or equal to about 1 nm to less than or equal to about 100 nm. The carbon coating may have a thickness greater than or equal to 1 nm to less than or equal to 100 nm.

The carbon coating may be a substantially continuous coating covering, for example, greater than or equal to about 80%, optionally greater than or equal to about 85%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total surface area of the micro/nano scale electroactive particles of the two-dimensional silicon oxide material.

The carbon coating may be a substantially continuous coating covering, for example, greater than or equal to 80%, optionally greater than or equal to 85%, optionally greater than or equal to 90%, optionally greater than or equal to 91%, optionally greater than or equal to 92%, optionally greater than or equal to 93%, optionally greater than or equal to 94%, optionally greater than or equal to 95%, optionally greater than or equal to 96%, optionally greater than or equal to 97%, optionally greater than or equal to 98%, optionally greater than or equal to 99%, and in certain aspects, optionally greater than or equal to 99.5%, of a total surface area of the micro/nano scale electroactive particles of the two-dimensional silicon oxide material.

In various aspects, the negative electroactive material may be a composite including a combination of the two-dimensional silicon oxide material, for example in the form of a first plurality of electroactive material particles, and another negative electroactive material, such as graphite, graphene, carbon nanotubes, carbon nanofibers, carbon black, or any combination thereof, for example in the form of a second plurality of electroactive material particles. In certain variations, the composite may include greater than or equal to about 5 wt. % to less than or equal to about 95 wt. % of the two-dimensional silicon oxide material, and greater than or equal to about 5 wt. % to less than or equal to about 95 wt. % of the other negative electroactive material. The composite may include greater than or equal to 5 wt. % to less than or equal to 95 wt. % of the two-dimensional silicon oxide material, and greater than or equal to 5 wt. % to less than or equal to 95 wt. % of the other negative electroactive material.

In still further variations, the negative electroactive material may be a composite include a combination of the two-dimensional silicon oxide material, for example in the form of a first plurality of electroactive material particles, and a three-dimensional allotrope (e.g., three-dimensional silicon allotrope (such as, pure Si, SiOx and LiₓSiOₓ), a carbon-coated three-dimensional allotrope, a two-dimensional allotrope, a carbon-coated two-dimensional allotrope, and the like, for example in the form of a second plurality of electroactive material particles. For example, the composite may include greater than or equal to about 5 wt. % to less than or equal to about 95 wt. % of the two-dimensional silicon oxide material, and greater than or equal to about 5 wt. % to less than or equal to about 95 wt. % of the three-dimensional silicon allotrope. The composite may include greater than or equal to 5 wt. % to less than or equal to 95 wt. % of the two-dimensional silicon oxide material, and greater than or equal to 5 wt. % to less than or equal to 95 wt. % of the three-dimensional silicon allotrope.

In each instance, the negative electroactive material may be pre-lithiated, so as to compensate for lithium losses during cycling, such as may result during conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) formation.

In various aspects, the layered anode material may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode 22 may include greater than or equal to about 10 wt. % to less than or equal to about 99 wt. % of the layered anode material, greater than or equal to 0 wt. % to less than or equal to about 20 wt. % of the electronically conducting material, and greater than or equal to 0 wt. % to less than or equal to about 20 wt. %, and in certain aspects, optionally greater than or equal to about 1 wt. % to less than or equal to about 20 wt. %, of the at least one polymeric binder.

The negative electrode 22 may include greater than or equal to 10 wt. % to less than or equal to 99 wt. % of the layered anode material, greater than or equal to 0 wt. % to less than or equal to 20 wt. % of the electronically conducting material, and greater than or equal to 0 wt. % to less than or equal to 20 wt. %, and in certain aspects, optionally greater than or equal to 1 wt. % to less than or equal to 20 wt. %, of the at least one polymeric binder.

In various aspects, the present disclosure provides methods of making a two-dimensional silicon oxide negative electroactive material, for use in negative electrodes, such as negative electrode 22 illustrated in FIG. 1. The methods may generally include contacting a two-dimensional silicon allotrope and an oxidizing agent (e.g., dilute oxygen and/or wet chemical agents) in an environment having a temperature greater than or equal to about 25° C. to less than or equal to about 1,000° C. The environment may have a temperature greater than or equal to 25° C. to less than or equal to 1,000° C. For example, in certain variations, methods for forming the two-dimensional silicon oxide material may include exposing a layered (i.e., two-dimensional) silicon allotrope to dilute oxygen, where the oxygen concentration and temperatures are controlled. In other variations, methods for forming the two-dimensional silicon oxide material may include exposing a layered silicon allotrope to one or more wet chemical agent (e.g., nitrates, peroxides, persulfates, permanganates, and the like), where the oxidizing powers and temperatures are controlled. In each instance, the layered silicon allotrope may be prepared using methods such as detailed in U.S. patent application Ser. No. 17/335,972, entitled “Electrochemical Exchange for the Fabrication of a Layered Anode Material,” to Jeffrey Cain et al., which was filed on Jun. 1, 2021; U.S. patent application Ser. No. 17/335,987, entitled “Passive Ion Exchange for the Fabrication of a Layered Anode Material,” to Jeffrey Cain et al., which was filed on Jun. 1, 2021; and/or U.S. patent application Ser. No. ______, led “Solid-State Synthesis for the Fabrication of a Layered Anode Material,” to Paul Taichiang Yu et al., which is filed on the same day herewith, the entire disclosures of which are hereby incorporated by reference._{[A1]}

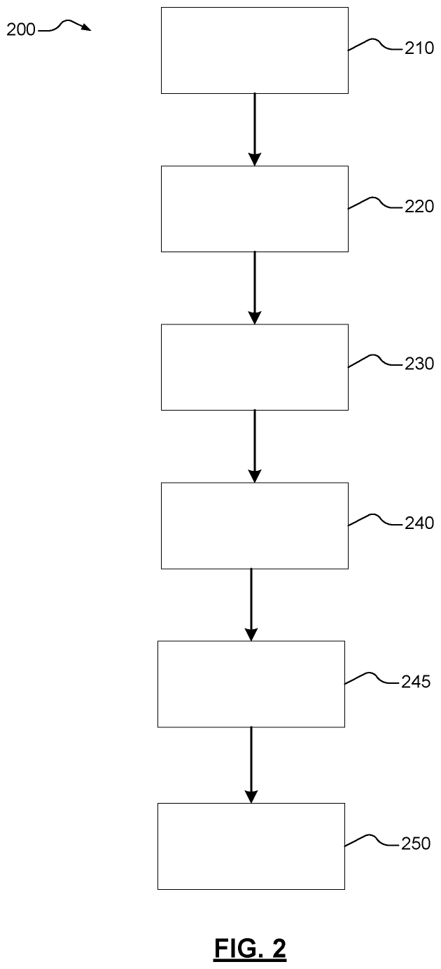

FIG. 2 illustrates an exemplary gas-phase method 200 for forming a two-dimensional silicon oxide negative electroactive material. The method 200 includes disposing 220 a layered silicon allotrope in an oxygen-containing environment, where the oxygen-containing environment has an oxygen concentration greater than or equal to about 0.5 vol. % to less than or equal to about 100 vol. %, and in certain aspects, optionally greater than or equal to about 1 vol. % to less than or equal to about 21 vol. %, and is maintained at a temperature greater than or equal to about 100° C. to less than or equal to about 1,000° C., and in certain aspects, optionally greater than or equal to about 600° C. to less than or equal to about 900° C. The oxygen-containing environment may have an oxygen concentration greater than or equal to 0.5 vol. % to less than or equal to 100 vol. %, and in certain aspects, optionally greater than or equal to 1 vol. % to less than or equal to 21 vol. %. The oxygen-containing environment may be maintained at a temperature greater than or equal to 100° C. to less than or equal to 1,000° C. and in certain aspects, optionally greater than or equal to 600° C. to less than or equal to 900° C.

Although not illustrated, the skilled artisan will understand that in certain variations, the method 200 may include disposing 220 the layered silicon allotrope in the oxygen-containing environment and subsequently or concurrently heating the oxygen-containing environment including the layered silicon allotrope to a temperature greater than or equal to about 100° C. to less than or equal to about 1,000° C., and in certain aspects, optionally greater than or equal to about 600° C. to less than or equal to about 900° C.

In each variations, the method 200 may include maintaining 230 the layered silicon allotrope in the high-temperature, oxygen-containing environment for greater than or equal to about 10 minutes to less than or equal to about 300 minutes, and in certain aspects, optionally greater than or equal to about 30 minutes to less than or equal to about 120 minutes. The method 200 may include maintaining 230 the layered silicon allotrope in the oxygen-containing environment for greater than or equal to 10 minutes to less than or equal to 3000 minutes, and in certain aspects, optionally greater than or equal to 30 minutes to less than or equal to 120 minutes. In certain variations, the method 200 may include preparing 210 the layered silicon allotrope.

In each variation, the method 200 may include one or more post treatments or surface enhancements. For example, in certain variations, the method 200 may include carbon coating the two-dimensional silicon oxide negative electroactive material. The two-dimensional silicon oxide negative electroactive may be carbon coated by exposing 240 the two-dimensional silicon oxide material to one or more carbon containing fuels at temperatures greater than or equal to about 100° C. to less than or equal to about 1,000° C., and in certain aspects, greater than or equal to about 600° C. to less than or equal to about 900° C. The two-dimensional silicon oxide negative electroactive may be carbon coated by exposing 240 the two-dimensional silicon oxide material to one or more carbon containing fuels at temperatures greater than or equal to 100° C. to less than or equal to 1,000° C., and in certain aspects, greater than or equal to 600° C. to less than or equal to 900° C. The one or more carbon containing fuels may include alkanes (e.g., methane), alkenes (e.g., ethylene, propylene), alkynes (e.g., acetylene), and the like.

Although not illustrated, the skilled artisan will understand that in certain variations, the method 200 may include disposing 240 the two-dimensional silicon oxide material in an environment including one or more carbon containing fuels and subsequently or concurrently heating the oxygen-containing environment including the layered silicon allotrope to temperatures greater than or equal to 100° C. to less than or equal to 1,000° C., and in certain aspects, greater than or equal to 600° C. to less than or equal to 900° C.

In certain variations, the method 200 may include pre-lithiating the two-dimensional silicon oxide negative electroactive material (and/or the carbon-coated, two-dimensional silicon oxide negative electroactive material). The two-dimensional silicon oxide negative electroactive may be pre-lithiated by exposing 245 the two-dimensional silicon oxide negative electroactive material to an organic electrolyte, where the organic electrolyte includes one or more lithium salts and one or more organic solvents. For example, the organic electrolyte may be have a molar concentration of the one or more lithium salts greater than or equal to about 0.1 M to less than or equal to about 4 M. The organic electrolyte may be have a molar concentration of the one or more lithium salts greater than or equal to 0.1 M to less than or equal to 4 M.

The one or more lithium salts may be selected from lithium hexafluorophosphate, lithium bis(fluorosulfonyl)imide, lithium tetrafluoroborate, lithium bis(oxalate)borate, and the like. The one or more organic solvents may include cyclic carbonate esters (e.g., ethylene carbonate, propylene carbonate, and the like) and/or esters (e.g., dimethylcarbonate, diethylcarbonate, ethylmethylcarbonate, and the like). Although the illustration shows the carbon coating the pre-lithiating as occurring in consecutive steps, the skilled artisan will appreciate that in certain variations, the methods steps as illustrated in FIG. 2 may occur in various orders and/or concurrently.

In various aspects, the method 200 may include incorporating 250 the two-dimensional silicon oxide negative electroactive (and optionally, the first current collector) and/or the carbon-coated two-dimensional silicon oxide negative electroactive (and optionally, the first current collector) and/or the pre-lithiated two-dimensional silicon oxide negative electroactive (and optionally, the first current collector) and/or the carbon-coated, prelithiated two-dimensional silicon oxide negative electroactive (and optionally, the first current collector) into a cell to be used as the negative electroactive material (and negative current collector). Although not illustrated, in various aspects, the method 200 may further include additional coating steps and/or other post-processing steps, for example to enhance air stability of the two-dimensional silicon oxide negative electroactive, and/or mixing the two-dimensional silicon oxide negative electroactive and another negative electroactive material, such as three a three-dimensional silicon allotrope and/or graphite/graphene, prior to incorporation into a cell.

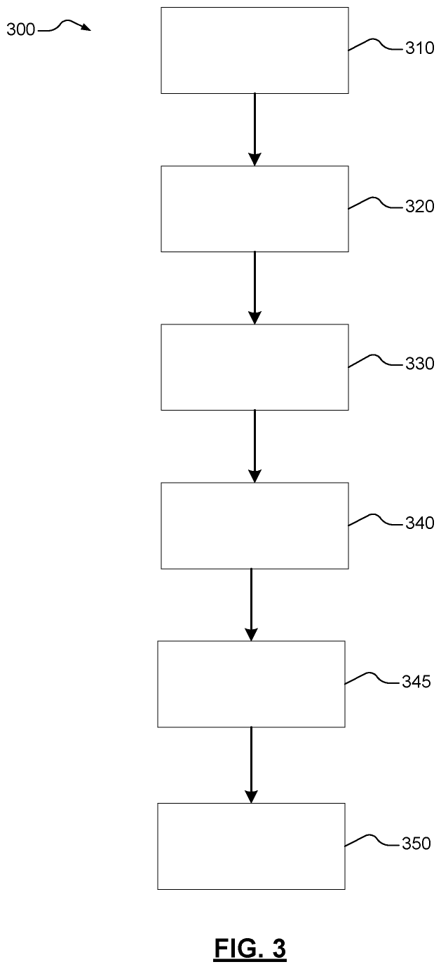

FIG. 3 illustrates an exemplary liquid-phase method 300 for forming a two-dimensional silicon oxide negative electroactive material. The method 300 includes contacting 320 a layered silicon allotrope and one or more wet chemical agents in an environment having a temperature greater than or equal to about 25° C. to less than or equal to about 100° C., and in certain aspects, optionally greater than or equal to about 25° C. to less than or equal to about 80% of the boiling temperature of the one or more wet chemical agents. The method 300 includes contacting 320 a layered silicon allotrope and one or more wet chemical agents in an environment having a temperature greater than or equal to 25° C. to less than or equal to 100° C., and in certain aspects, optionally greater than or equal to 25° C. to less than or equal to 80% of the boiling temperature of the one or more wet chemical agents.

Although not illustrated, the skilled artisan will understand that in certain variations, the method 300 may include contacting 320 the layered silicon allotrope and the one or more wet chemical agents to form an admixture and subsequently or concurrently heating the admixture to a temperature greater than or equal to about 25° C. to less than or equal to about 100° C., and in certain aspects, optionally greater than or equal to about 25° C. to less than or equal to about 80% of the boiling temperature of the one or more wet chemical agents.

In each instance, contacting 320 the layered silicon allotrope and the one or more wet chemical agents includes sufficiently wetting (i.e., including excess of the one or more wet chemical agents) to wet the layered silicon allotrope. The one or more wet chemical agents may have a desirable, or predetermined, oxidizing power. For example, in certain variations, the one or more wet chemical agents may include nitrites, nitrates (e.g., nitric acid, sodium nitrate, and the like), peroxides (e.g., hydrogen peroxide and the like), sulfites, sulfates, persulfates (e.g., sodium persulfate and the like), sulfuric acid, chlorates, chlorites, peroxymonosulfuric acid, peroxydisulfuric acid, and/or permanganates (e.g., potassium permanganate and the like).

The method 300 may include maintaining 330 the contact between the layered silicon allotrope and the one or more wet chemical agents for greater than or equal to about 5 minutes to less than or equal to about 300 minutes, and in certain aspects, optionally greater than or equal to about 15 minutes to less than or equal to about 60 minutes, in the high-temperature environment. The method 300 may include maintaining 330 the contact between the layered silicon allotrope and the one or more wet chemical agents for greater than or equal to 5 minutes to less than or equal to 300 minutes, and in certain aspects, optionally greater than or equal to 15 minutes to less than or equal to 60 minutes. In certain variations, the method 300 may include preparing 310 the layered silicon allotrope. Although not illustrated, the skilled artisan will recognize that in various aspects, the method 300 may further include one or more rinsing and/or drying steps following the step 300. The drying steps may be performed using a vacuum and/or in an inert atmosphere.

In each variation, the method 300 may include one or more post treatments or surface enhancements. For example, in certain variations, the method 300 may include carbon coating the two-dimensional silicon oxide negative electroactive material. The two-dimensional silicon oxide negative electroactive may be carbon coated by exposing 340 the two-dimensional silicon oxide material to one or more carbon containing fuels at temperatures greater than or equal to about 100° C. to less than or equal to about 1,000° C., and in certain aspects, optionally greater than or equal to about 600° C. to less than or equal to about 900° C. The two-dimensional silicon oxide negative electroactive may be carbon coated by exposing 340 the two-dimensional silicon oxide material to one or more carbon containing fuels at temperatures greater than or equal to 100° C. to less than or equal to 1,000° C., and in certain aspects, optionally greater than or equal to 600° C. to less than or equal to 900° C. The one or more carbon containing fuels may include alkanes (e.g., methane), alkenes (e.g., ethylene, propylene), alkynes (e.g., acetylene), and the like.

Although not illustrated, the skilled artisan will understand that in certain variations, the method 300 may include disposing 340 the two-dimensional silicon oxide material in an environment including one or more carbon containing fuels and subsequently or concurrently heating the oxygen-containing environment including the layered silicon allotrope to temperatures greater than or equal to 100° C. to less than or equal to 1,000° C., and in certain aspects, greater than or equal to 600° C. to less than or equal to 900° C.

In certain variations, the method 300 may include pre-lithiating the two-dimensional silicon oxide negative electroactive material (and/or the carbon-coated, two-dimensional silicon oxide negative electroactive material). The two-dimensional silicon oxide negative electroactive may be pre-lithiated by exposing 345 the two-dimensional silicon oxide negative electroactive material to an organic electrolyte, where the organic electrolyte includes one or more lithium salts and one or more organic solvents. The one or more lithium salts may be selected from lithium hexafluorophosphate, lithium bis(fluorosulfonyl)imide, lithium tetrafluoroborate, lithium bis(oxalate)borate, and the like. The one or more organic solvents may include cyclic carbonate esters (e.g., ethylene carbonate, propylene carbonate, and the like) and/or esters (e.g., dimethylcarbonate, diethylcarbonate, ethylmethylcarbonate, and the like). Although the illustration shows the carbon coating the pre-lithiating as occurring in consecutive steps, the skilled artisan will appreciate that in certain variations, the methods steps as illustrated in FIG. 3 may occur in various orders and/or concurrently.

In various aspects, the method 300 may include incorporating 350 the two-dimensional silicon oxide negative electroactive (and optionally, the first current collector) and/or the carbon-coated two-dimensional silicon oxide negative electroactive (and optionally, the first current collector) and/or the pre-lithiated two-dimensional silicon oxide negative electroactive (and optionally, the first current collector) and/or the carbon-coated, prelithiated two-dimensional silicon oxide negative electroactive (and optionally, the first current collector) into a cell to be used as the negative electroactive material (and negative current collector). Although not illustrated, in various aspects, the method 300 may further include additional coating steps and/or other post-processing steps, for example to enhance air stability of the two-dimensional silicon oxide negative electroactive, and/or mixing the two-dimensional silicon oxide negative electroactive and another negative electroactive material, such as three a three-dimensional silicon allotrope and/or graphite/graphene, prior to incorporation into a cell.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a two-dimensional silicon oxide negative electroactive material, the method comprising:
contacting a two-dimensional silicon allotrope and an oxidizing agent in an environment having a temperature of greater than or equal to about 25° C. to less than or equal to about 1,000° C., wherein the contacting of the two-dimensional silicon allotrope and the oxidizing agent causes the two-dimensional silicon allotrope to oxidize and form the two-dimensional silicon oxide negative electroactive material.

2. The method of claim 1, further comprising, prior to or simultaneously with the contacting of the two-dimensional silicon allotrope and the oxidizing agent:
heating the environment to the temperature of greater than or equal to about 25° C. to less than or equal to about 1,000° C.

3. The method of claim 1, wherein the environment has a temperature greater than or equal to about 100° C. to less than or equal to about 1,000° C., the oxidizing agent comprises oxygen, and the contacting of the two-dimensional silicon allotrope and the oxidizing agent comprises disposing the two-dimensional silicon allotrope in an oxygen-containing environment comprising less than or equal to about 21% of oxygen.

4. The method of claim 3, wherein the oxygen-containing environment has an oxygen concentration greater than or equal to about 1 vol. % to less than or equal to about 21 vol. %.

5. The method of claim 3, wherein the two-dimensional silicon allotrope is maintained in the oxygen-containing environment for greater than or equal to about 10 minutes to less than or equal to about 300 minutes.

6. The method of claim 1, wherein the oxidizing agent comprises a wet chemical agent.

7. The method of claim 6, wherein the wet chemical agent comprises one or more nitrates, one or more peroxides, one or more persulfates, one or more permanganates, or any combination thereof.

8. The method of claim 7, wherein the wet chemical agent comprises a compound selected from the group consisting of: nitrite, nitrate, peroxide, sulfite, sulfate, persulfate, sulfuric acid, chlorate, chlorite, peroxymonosulfuric acid, peroxydisulfuric acid, permanganate, and combinations thereof.

9. The method of claim 1, further comprising, after the contacting:
carbon coating the two-dimensional silicon oxide negative electroactive material, wherein the two-dimensional silicon oxide negative electroactive material is carbon coated by exposing the two-dimensional silicon oxide material to one or more carbon containing fuels at temperatures of greater than or equal to about 600° C. to less than or equal to about 1,000° C.

10. The method of claim 1, further comprising, after the contacting:
prelithiating the two-dimensional silicon oxide negative electroactive material, wherein the two-dimensional silicon oxide negative electroactive material is prelithiated by exposing the two-dimensional silicon oxide negative electroactive material to an organic electrolyte.

11. The method of claim 10, wherein the organic electrolyte comprises:
a lithium salt selected from the group consisting of: lithium hexafluorophosphate, lithium bis(fluorosulfonyl)imide, lithium tetrafluoroborate, lithium bis(oxalate)borate, and combinations thereof; and
an organic solvent selected from the group consisting of: ethylene carbonate, propylene carbonate, dimethylcarbonate, diethylcarbonate, ethylmethylcarbonate, and combinations thereof.

12. A method for forming a two-dimensional silicon oxide negative electroactive material, the method comprising:
disposing a two-dimensional silicon allotrope in an oxygen-containing environment, wherein the oxygen-containing environment is heated to a temperature of greater than or equal to about 100° C. to less than or equal to about 1,000° C. and has an oxygen concentration of greater than or equal to about 1 vol. % to less than or equal to about 21 vol. %, and wherein heating the two-dimensional silicon allotrope in the oxygen-containing environment causes the two-dimensional silicon allotrope to oxidize and form the two-dimensional silicon oxide negative electroactive material.

13. The method of claim 12, wherein the two-dimensional silicon allotrope is maintained in the oxygen-containing environment for greater than or equal to about 10 minutes to less than or equal to about 300 minutes.

14. The method of claim 12, further comprising, after the contacting:
carbon coating the two-dimensional silicon oxide negative electroactive material, wherein the two-dimensional silicon oxide negative electroactive material is carbon coated by exposing the two-dimensional silicon oxide material to one or more carbon containing fuels at temperatures greater than or equal to about 600° C. to less than or equal to about 1,000° C.

15. The method of claim 12, further comprising, after the contacting:
prelithiating the two-dimensional silicon oxide negative electroactive material, wherein the two-dimensional silicon oxide negative electroactive material is prelithiated by exposing the two-dimensional silicon oxide negative electroactive material to an organic electrolyte.

16. A method for forming a two-dimensional silicon oxide negative electroactive material, the method comprising:
contacting a two-dimensional silicon allotrope and a wet chemical agent to form an admixture; and
heating the admixture to a temperature of greater than or equal to about 25° C. to less than or equal to about 100° C., wherein the heating of the admixture causes the two-dimensional silicon allotrope to oxidize and form the two-dimensional silicon oxide negative electroactive material.

17. The method of claim 16, wherein the wet chemical agent comprises one or more nitrates, one or more peroxides, one or more persulfates, one or more permanganates, or any combination thereof.

18. The method of claim 17, wherein the wet chemical agent comprises a compound selected from the group consisting of: nitrite, nitrate, peroxide, sulfite, sulfate, persulfate, sulfuric acid, chlorate, chlorite, peroxymonosulfuric acid, peroxydisulfuric acid, permanganate, and combinations thereof.

19. The method of claim 15, further comprising, after the contacting:
carbon coating the two-dimensional silicon oxide negative electroactive material, wherein the two-dimensional silicon oxide negative electroactive material is carbon coated by exposing the two-dimensional silicon oxide material to one or more carbon containing fuels at temperatures of greater than or equal to about 600° C. to less than or equal to about 1,000° C.

20. The method of claim 16, further comprising, after the contacting:
prelithiating the two-dimensional silicon oxide negative electroactive material, wherein the two-dimensional silicon oxide negative electroactive material is prelithiated by exposing the two-dimensional silicon oxide negative electroactive material to an organic electrolyte.
